(19) United States
(12) Patent Application Publication
(10) Pub. No.: US 2009/0164181 A1
(43) Pub. Date: Jun. 25, 2009

(54) Apparatus and Method for Modeling MOS Transistor

(76) Inventor: Seok Yong KO, Bucheon-si (KR)

Correspondence Address: THE LAW OFFICES OF ANDREW D. FORTNEY, PH.D., P.C., 401 W FALLBROOK AVE STE 204, FRESNO, CA, 93711-5835, US

(21) Appl. No.: 12/341,612

(22) Filed: Dec. 22, 2008

(30) Foreign Application Priority Data
Dec. 24, 2007 (KR) 10-2007-0136538

(51) Int. Cl. G06F 17/10; G06F 17/50

(52) U.S. Cl. 703/2; 703/16

(57) ABSTRACT

Disclosed are an apparatus and a method for modeling a MOSFET (Metal-Oxide Semiconductor Field Effect Transistor). The method includes establishing an equation and a variable that determine the driving current characteristics of the MOS transistor; generating a random number; converting the random number such that the random number has a value satisfying an equation of a rotated lozenge and determining a variation degree of the variable based on the value of the random number; and outputting the driving current distribution of the MOS transistor using the equation and the variation degree of the variable.

The present application claims priority under 35 U.S.C. § 119(e) of Korean Patent Application No. 10-2007-0136538 (filed on Dec. 24, 2007), which is hereby incorporated by reference in its entirety.

### BACKGROUND

Embodiments of the invention relate to an apparatus and a method for modeling a MOSFET (Metal-Oxide Semiconductor Field Effect Transistor).

Recently, the semiconductor manufacturing technology has tendency to fabricate a semiconductor chip in a small size. Such a semiconductor chip can improve the operational speed of electric appliances, such as a computer, a cellular phone, a disk player, etc., while enabling the electric appliances to be fabricated in a smaller size with a compact structure.

In order to fabricate the electric devices in a smaller size, internal elements of the electric devices must be fabricated in a small size. For instance, in order to obtain transistors having a smaller size, theoretical design modeling and simulation work thereof are performed before the transistors are fabricated. In addition, the simulation results are fed back to the designers when designing semiconductor integrated circuits.

FIG. 1 is a view showing driving current distribution of a p-MOS transistor and an n-MOS transistor.

FIG. 1 is obtained by measuring the driving current after forming a plurality of p-MOS transistors and n-MOS transistors on a wafer. In FIG. 1, Mea (¤) represents measurement values of the driving current of the p-MOS transistors and n-MOS transistors when a width W of a gate electrode is 10 μm, and a channel length L of the gate electrode is 0.18 μm.

Meanwhile, the SPICE model has been proposed to allow a designer to take the driving current distribution of the p-MOS transistors and n-MOS transistors shown in FIG. 1 into consideration.

FIG. 2 is a view showing the 5-corner model and the statistical model, which are generally used in simulation of the driving current distribution of the p-MOS transistor and the n-MOS transistor.

As shown in FIG. 2, the 5-corner model represents the driving current distribution by using five points.

The 5-corner model includes a TT (Typical) model in which the driving current of the n-MOS transistor and p-MOS transistor has an average value, an FF (Fast-Fast) model in which the driving current of the n-MOS transistor and p-MOS transistor has the maximum value, an SS (Slow-Slow) model in which the driving current of the n-MOS transistor and p-MOS transistor has the minimum value, an FS (Fast-Slow) model in which the driving current of the n-MOS transistor has a high value and the driving current of the p-MOS transistor has a low value, and an SF (Slow-Fast) model in which the driving current of the n-MOS transistor has a low value and the driving current of the p-MOS transistor has a high value.

In addition, as shown in FIG. 2 by asterisks (*), the statistical model represents the driving current distribution similar to the actual driving current distribution. According to the statistical model, random numbers are generated through the Monte Carlo scheme so that the driving current distribution obtained through the simulation can to similar to the actual driving current distribution obtained through measurement.

Meanwhile, the designer must take the worst case and the best case into consideration when designing the n-MOS transistor and p-MOS transistor.

However, the 5-corner model generally uses several modeling procedures (many SPICE model libraries) to confirm various worst cases and best cases, and the statistical model generally uses many Monte Carlo simulation processes.

### SUMMARY

Embodiments of the invention provide an apparatus and a method for modeling a MOS transistor.

Certain embodiments of the invention provide an apparatus and a method for modeling a MOS transistor, capable of easily verifying the worst case and the best case.

Other embodiments provide an apparatus and a method for modeling a MOS transistor, capable of verifying various worst cases and best cases through a smaller number of Monte Carlo simulation processes as compared with the related art.

According to disclosed embodiments, there is provided a modeling method for verifying driving current characteristics of a MOS transistor through a SPICE program, the method comprising the steps of: establishing an equation and a variable that determine the driving current characteristics of the MOS transistor; generating a random number; converting the random number such that the random number has a value satisfying an equation of a rotated lozenge and determining a variation degree of the variable based on the value of the random number; and outputting driving current distribution of the MOS transistor using the equation and the variation degree of the variable.

According to various embodiments, there is provided a modeling apparatus for verifying driving current characteristics of a MOS transistor through a SPICE program, the modeling apparatus comprising: a computer readable medium storing instructions to simulate the driving current characteristics, wherein the instructions define an equation and a variable that determine the driving current characteristics of the MOS transistor, generate a random number, convert the random number such that the random number has a value satisfying an equation of a rotated lozenge, determine a variation degree of the variable based on the value of the random number, and calculate the driving current distribution of the MOS transistor using the equation and the variation degree of the variable.

### BRIEF DESCRIPTION OF THE DRAWINGS

FIG. 1 is a view showing driving current distribution of a p-MOS transistor and an n-MOS transistor;

FIG. 2 is a view showing the 5-corner model and the statistical model, which are generally used in simulation of the driving current distribution of the p-MOS transistor and the n-MOS transistor;

FIG. 3 is a view showing an exemplary apparatus for modeling a MOS transistor; and

FIG. 4 is a view showing a simulation result obtained through an exemplary method for modeling a MOS transistor according to the present invention.

### DETAILED DESCRIPTION OF THE EMBODIMENTS

Hereinafter, an apparatus and a method for modeling a MOS transistor according to embodiments of the invention will be described with reference to accompanying drawings.

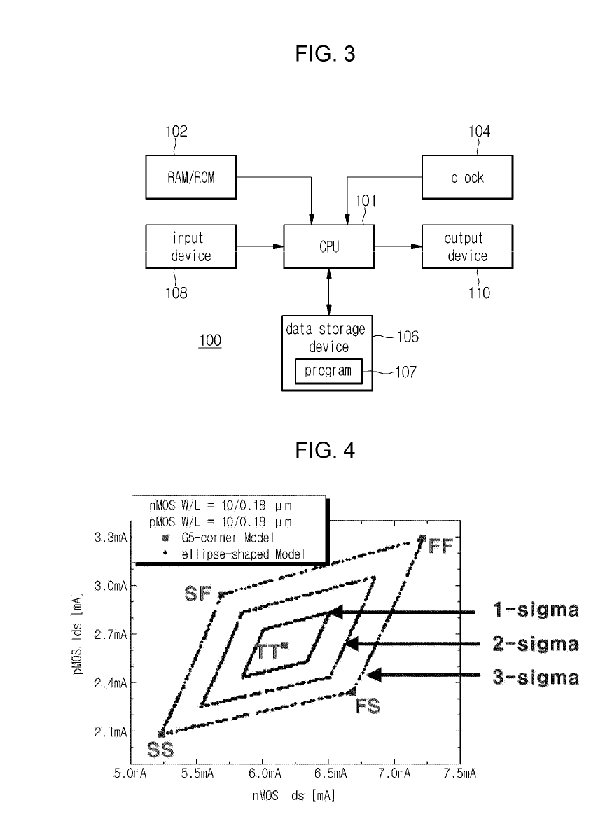

FIG. 3 is a view showing an exemplary apparatus for modeling a MOS transistor. Referring to FIG. 3, the modeling apparatus 100 is in the form of hardware, or a computer system.

The modeling apparatus 100 receives program instructions and a user's input(s), and outputs results corresponding to the instructions and the user's input(s). The modeling apparatus 100 includes a CPU (central processing unit) 101, such as a microprocessor available from Intel Corporation. The CPU 101 cooperates with an RAM/ROM 102, a clock 104, a data storage device 106, an input device 108, and an output device 110.

The RAM (Random Access Memory) includes memory modules having storage capacity sufficient for storing processing instructions used by the CPU 101. The ROM (Read Only Memory) includes a permanent memory medium capable of storing instructions performed by the CPU 101 during the start routine of the modeling apparatus 100. Other functions of the RAM/ROM 102 are generally known in the art.

The clock 104 can be accommodated in the CPU 101 in order to regulate the clock speed when the CPU 101 synchronizes and performs communication with the above hardware elements of the modeling apparatus 100. Other functions of the clock 104 are generally known in the art.

The input device 108 includes at least one device available to the public and used to communicate with other computer systems or the modeling apparatus 100 based on the user's inputs. That is, the input device 108 may include a keyboard, a mouse, a scanner, a sound recognition unit, a serial/parallel communication port, a network card suitable for network access and data reception, or a communication card. The input device 108 allows the user to input instructions and specific values.

The output device 110 includes at least one device available to the public and used to represent or display the results to the user of the modeling apparatus 100 according to the input instructions and specific values input by the user. That is, the output device 110 may include a display monitor, a speech synthesizer, a printer, a serial/parallel communication port, a network card suitable for network access and data transmission, or a communication card. The output device 110 allows the user to receive the results according to the instructions and specific values input by the user.

The data storage device 106 may be an internal mass-storage memory and/or an external mass-storage memory used for storing computer data. The storage capacity of the data storage device 106 may be above the gigabyte density (e.g., 2, 10 or 100 gigabytes or more). For instance, the data storage device 106 stores an operating system of Microsoft Corporation and least one application program, such as a program 107. That is, the data storage device 106 may be at least one of a hard disk drive, a CD-ROM disk and reader/writer, a DVD disk and reader/writer, a ZIP disk drive, and a computer readable medium which can be encoded with processing instructions of a read-only format or a read-write format. Other functions of the data storage device 106 and other available storage devices are generally known in the art.

The program 107 allows the modeling apparatus 100 to receive data and information and includes a plurality of processing instructions that may determine driving current characteristics of a MOSFET device.

According to various embodiments, the program 107 allows the worst case and the best case of the driving current characteristic to be distributed in the form of a rotated lozenge through Monte Carlo simulation processes based on the SPICE program, so that the designer can verify various worst cases and best cases.

Meanwhile, the driving current characteristics of the MOSFET device can be determined according to Equation 1 below.

$$Ids = Ueff \times Cox \frac{W}{L} ( Vgs - Vt - \frac{1}{2} Vds ) \times Vds \qquad Equation 1$$

In Equation 1, Ids is the driving current, Ueff is the effective mobility of an electron or a hole, Cox is the capacitance per a unit channel area, W is a width of a gate electrode, L is a channel length of the gate electrode, Vgs is gate voltage, Vt is the threshold voltage of the transistor, and Vds is drain voltage.

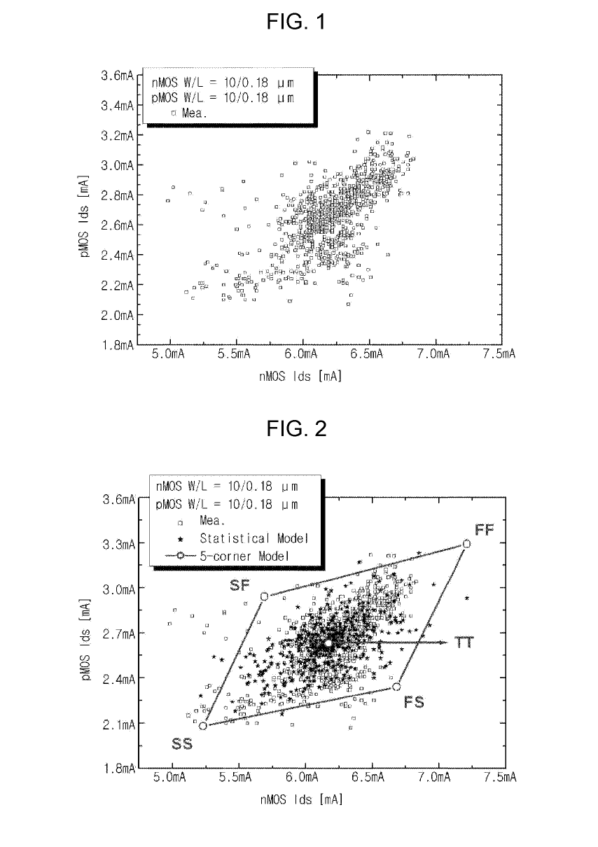

Referring to FIG. 1, the driving current distribution can be obtained by changing N_TOX (n-MOS) and P_TOX (p-MOS) that are n-MOS and p-MOS variations of Cox, respectively; N_VTHO and P_VTHO that are n-MOS and p-MOS variations of Vt, N_XL and P_XL that are n-MOS and p-MOS variations of L, and N_XW and P_XW that are n-MOS and p-MOS variations of W.

According to one embodiment, the program (107) serving as the SPICE program includes following codes.

.LIB MCNO_018
.param

| + | psigma=abs(sig) sig=agauss(0,1,3) | [3-1] |
|---|---|---|
| + | pan=aunif(0,3) | [3-2] |
| + | px=‘pan’ con=limit(0,1) ma=‘(px<0)? 0.5:−0.5’ | [3-3] |
| + | py=‘con*(ma*px+1.5)’ | [3-4] |
| + | pang=‘3.141592*45/180’ | [3-5] |
| + | PN=‘(px*cos(pang)−py*sin(pang))/sin(pang)’ | |
| | PP=‘(px*sin(pang)+py*cos(pang))/sin(pang)’ | [3-6] |
| + | N_TOX=‘1.54e−10*(PN/3)*psigma’ | |
| | P_TOX=‘1.54e−10*(PP/3)*psigma’ | [3-7] |
| + | N_VTHO=‘9.00e−02*(PN/3*psigma’ | |
| | P_VTHO=‘9.00e−02*(PP/3)*psigma’ | [3-8] |
| + | N_XL=‘1.20e−08*(PN/3)*psigma’ | |
| | P_XL=‘1.20e−08*(PP/3)*psigma’ | [3-9] |
| + | N_XW=‘2.20e−08*(−PN/3)*psigma’ | |
| | P_XW=‘2.20e−08*(−PP/3)*psigma’ | [3-10] |

In the above SPICE program, .param represents definitions of parameters.

In Equation [3-1], “psigma” is an absolute value of a random number which is 3-sigma generated about 0 from a range of +1 to −1.

In Equation [3-2], “pan” is a value of a random number having uniform distribution in a range of −3 to +3.

Equations [3-3] and [3-4] define a value of “px”, and “con” is a function that repeats −1 and 1. A gradient (ma) is 0.5 in a region where “px” has a negative value, and the gradient (ma) is −0.5 in a region where “px” has a positive value. In addition, a value of “py” is defined. The “px” and “py” satisfy the equation of the lozenge (oval). The lozenge has a coordinate in which the center is 0, and vertex points are (−3, 0), (0, 1.5), (3, 0), and (0, −1.5).

Equations [3-5] and [3-6] are used to rotate the lozenge defined by Equations [3-3] and [3-4] at an angle of 45 degrees.

Equations [3-7] to [3-10] are used to apply the rotated lozenge, which is defined by Equations [3-5] and [3-6], as a variable of main model parameters of the n-MOS and p-MOS transistors.

In one embodiment, N_TOX and P_TOX, N_VTHO and P_VTHO, N_XL and P_XL, and N_XW and P_XW are used as variables in the simulation for the driving current distribution of the MOSFET device.

FIG. 4 is a view showing a simulation result obtained through a method for modeling a MOS transistor according to an embodiment of the present invention. As shown in FIG. 4, the simulation result represents that the driving current characteristic of the MOS transistor exists within the rotated lozenge.

In FIG. 4, 1-sigma, 2-sigma, and 3-sigma indicate lozenges when the “psigma” of Equation [3-1] is defined as 0.68, 0.95 and 0.99 (substantially 1), respectively. That is, 1-sigma, 2-sigma, and 3-sigma represent the worst cases and best cases when the actual MOS transistor has an error within a range of 1-sigma, 2-sigma, and 3-sigma, respectively. Thus, various worst cases and best cases can be verified using one model by determining the value of “psigma” through the SPICE program.

If the value of “psigma” is defined as a specific value having 3-sigma about 0 and selected from the range of −1 to +1, the driving current distribution is expressed as plural lozenges within the range of 3-sigma (lozenge) shown in FIG. 4.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for verifying driving current characteristics of a MOS transistor, the method comprising the steps of:
establishing an equation and a variable that determine the driving current characteristics of the MOS transistor;
generating a random number;
converting the random number such that the random number has a value satisfying an equation of a rotated lozenge and determining a variation degree of the variable based on the value of the random number; and
outputting driving current distribution of the MOS transistor using the equation and the variation degree of the variable.

2. The method of claim 1, wherein the equation includes:
$$Ids = Ueff \times Cox \frac{W}{L} ( Vgs - Vt - \frac{1}{2} Vds ) \times Vds$$
wherein Ids is the driving current, Ueff is an effective mobility of an electron or a hole, Cox is a capacitance per unit channel area, W is a width of a gate electrode, L is a channel length of the gate electrode, Vgs is a gate voltage, Vt is a threshold voltage of the MOS transistor, and Vds is a drain voltage.

3. The method of claim 2, wherein Cox, Vt, L, and W serve as the variables in the equation.

4. The method of claim 1, wherein the driving current distribution is defined within one lozenge when the random number has a fixed value.

5. The method of claim 4, wherein a size of the lozenge changes according to the random number.

6. The method of claim 1, wherein the driving current characteristics of the MOS transistor are verified using a SPICE program or model.

7. An apparatus for verifying driving current characteristics of a MOS transistor, comprising:
a computer readable medium storing instructions to simulate the driving current characteristics, wherein the instructions determine an equation and a variable that determine the driving current characteristics of the MOS transistor, generate a random number, convert the random number such that the random number has a value satisfying an equation of a rotated lozenge, determine a variation degree of the variable based on the value of the random number, and calculate the driving current distribution of the MOS transistor using the equation and the variation degree of the variable.

8. The apparatus of claim 7, wherein the equation includes:
$$Ids = Ueff \times Cox \frac{W}{L} ( Vgs - Vt - \frac{1}{2} Vds ) \times Vds$$
wherein Ids is the driving current, Ueff is an effective mobility of an electron or a hole, Cox is a capacitance per unit channel area, W is a width of a gate electrode, L is a channel length of the gate electrode, Vgs is a gate voltage, Vt is a threshold voltage of the MOS transistor, and Vds is a drain voltage.

9. The apparatus of claim 8, wherein the Cox, Vt, L, and W serve as the variables in the equation.

10. The apparatus of claim 7, wherein the driving current distribution is defined within one lozenge when the random number has a fixed value.

11. The apparatus of claim 10, wherein a size of the lozenge changes according to the random number.

12. The apparatus of claim 7, wherein the driving current characteristics of the MOS transistor are verified using a SPICE program or model.
